(19) United States
(12) Patent Application Publication
(10) Pub. No.: US 2006/0219642 A1
(43) Pub. Date: Oct. 5, 2006

(54) Control system and method for an air-operated pump

(75) Inventors: Andrew M. Farnham, Edgerton, OH (US); Gordon M. Schroeder, New Bavaria, OH (US)

Correspondence Address: MICHAEL BEST & FRIEDRICH, LLP, 100 E WISCONSIN AVENUE, MILWAUKEE, WI, 53202, US

(73) Assignee: Ingersoll-Rand Company, Montvale, NJ (US)

(21) Appl. No.: 11/098,294

(22) Filed: Apr. 4, 2005

(51) Int. Cl. B01D 37/04

(52) U.S. Cl. 210/739; 210/137; 210/222

(57) ABSTRACT

A control system for the control of an air-controlled pump for pumping slurry to a filter press includes a transducer producing an output signal indicative of the actual rate of the pump. A controller includes an adjustable setpoint mechanism for setting a desired pump rate, and receives the output signal from the transducer and compares the actual pump rate to a set desired pump rate to produce a control signal. An air pressure regulator outputs a controlled air supply to the air supply port of the pump in response to the control signal.

### FIELD OF THE INVENTION

The invention relates to a control system and method for an air-operated pump, and in particular, to a control system and method for controlling an air-operated pump that pumps slurry to a filter press.

### BACKGROUND OF THE INVENTION

One of the most common air-operated pumps used in industry is a double-diaphragm, positive displacement type pump. Such a pump is self-priming and displaces fluid from one of its two liquid chambers upon the completion of each pump stroke. One application for such an air-operated pump is to provide the inlet pressure for process batch filtering of an influent stream, such as slurry, in a filter press. Of the many types of batch filters, membrane plate filters are the majority produced for today's markets. As a fixed volume filter, a membrane plate filter requires a specific quantity of solids in the total influent stream for the filter press to work effectively. Batch refers to the operation of the filter press as a cyclical filtering device that requires interruption of the process to discharge the collected solids or filter cake at a certain point.

The filter press is typically made up of two principle components: a filter pack and a press frame. The press frame holds the filter pack together against the pressures developed internally during the filtration process and also provides for the influent and effluent connections with the filter pack. Liquid-to-solid separation takes place in the filter pack. The filter pack consists of a series of alternating filter elements that form a series of chambers in the press frame. Each chamber has a series of raised cylinders or grooves covered with a porous medium that forms a drain field. The grooves or cylinders form a flow path for the liquid draining from the press. At alternating corners of the drain field, interconnecting holes join the drain field to the four corner discharge ports. The filter elements are held together in a plate pack whereby the corner discharge eyes form individual manifolds connecting the drain fields of the plates with the external piping of the press. A center feed inlet port forms a manifold that connects with the individual collection chambers of the filter pack. In operation, an influent, such as a solids-laden slurry is pumped under pressure by a pump into the press chambers through the center feed inlet port at the stationary end of the filter press. As each cake chamber fills with slurry, the liquid passes through the porous medium, across the drain field, through the drain ports and exits via gravity out of the corner discharge eyes.

The function of the filter media in press filtration is to provide a porous support structure for the filter cake as it develops and builds. Some solids may pass through the filter media initially, causing a slight turbidity in the filtrate, but the larger particles within the slurry gradually begin to bridge the openings in the filter media, reducing the effective opening size. This allows smaller particles to bridge these reduced openings initiating the cake filtration process. Once a layer of solid particles achieves 1 to 2 mm in thickness, this pre-coat layer serves to separate out finer and finer particles as the cake builds in thickness, yielding a filtrate which is very low in turbidity.

The driving pressure behind the slurry is typically 100 psi, but can be up to 900 psi (7 to 60 bar). The pressure is typically provided by a positive displacement or high head centrifugal feed pump. With a gravity drain on the filtrate side of the press, a pressure differential between the feed pressure and the gravity discharge is created across the filter media and filter cake solids as they build in thickness. This pressure differential, in conjunction with feed pump pressure, causes the filtering action to occur. Solids within the slurry will flow to the area of cake development with the lowest pressure differential, resulting in a filter cake which builds uniformly over the drain-field on either side of the chamber walls. This is the basic process.

The deposition of solids continues until the filter cakes forming on the individual chamber walls bridge at the center, completely filling the press with solids. It is at this point that the filtration process is complete. Once this is achieved, the hydraulic closure of the press is retracted, the individual filter elements are separated and the collected solids (filter cake) are discharged, usually by gravity, to an appropriate receptacle.

However, during the filtration process, a problem of increasing backpressure develops as the filter pack becomes full. The problem of maintaining a constant flow rate across the filter media becomes an issue, since increasing backpressure will slow the output of a positive displacement pump, unless the air pressure of air supplied to the pump is altered.

Prior art attempts for controlling air-operated pumps pumping slurry to a filter press operate to maintain a constant pressure differential and include the use of a programmable logic controller (PLC), a pressure sensor for measuring the pressure at the pump outlet and generating a pressure signal to the PLC, and a bank of valves under the control of the PLC to vary the air pressure supplied to the air-controlled pump. The pressure sensor is thus a part of an independent instrument loop that requires a separate power supply and a PLC controller including PID control. In particular, the PLC monitors the pressure signal and controls a group of solenoid operated valves coupled to a common header supplying air pressure to operate the pump. Depending upon the pressure setpoint, each valve opens an air supply at a different supply pressure, thereby adding or subtracting pressure supplied to the pump to thereby vary the pump speed. The air pressure supplied to the pump determines the cyclical rate of operation and the resulting output pressure. The prior art method is limited by the number of supply pressures and that the PLC has to be programmed.

What is needed is an inexpensive control system for an air-operated pump for a filter press which offers simple operation, no programming, and reliable pump control.

### SUMMARY OF THE INVENTION

The invention provides a control system for the control of an air-operated pump pumping slurry to a filter press. The air-controlled pump includes a liquid inlet for receiving the slurry and a liquid outlet supplying the slurry to the filter press. The rate of the pump is dependent on an air pressure of the air received at an air supply inlet. The control system includes a transducer, and a controller. The transducer produces an output signal indicative of the actual rate of the pump. The controller includes an adjustable setpoint mechanism for setting a desired pump rate, and receives the output signal from the transducer and compares the actual pump rate to the set desired pump rate. The controller also includes an air pressure regulator. The controller produces a control signal and the air pressure regulator outputs a controlled air pressure air supply to the pump in response to the control signal.

Other features and advantages of the invention will become apparent to those skilled in the art upon review of the following detailed description, claims, and drawings.

### BRIEF DESCRIPTION OF THE DRAWINGS

FIG. 1 is an illustration of one embodiment of a control system for the control of a pump pumping slurry to a filter press;

FIG. 2 is a schematic diagram of a controlled pump for use in the control system of FIG. 1; and

FIG. 3 is a schematic diagram of a controller according to one embodiment for use in the control system of FIG. 1.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

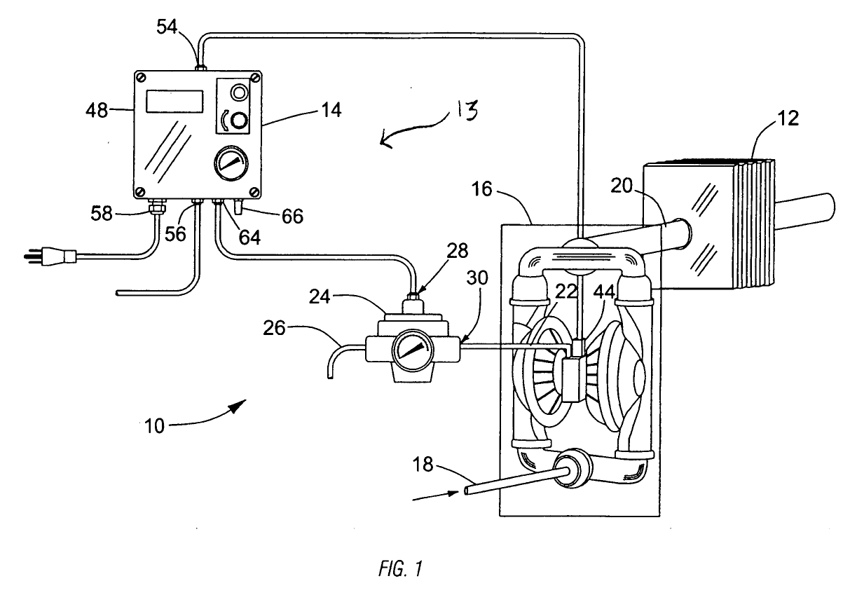

FIG. 1 illustrates one embodiment of a control system 10 for a filter press 12. In particular, FIG. 1 illustrates a controller 13 in a process control loop controlling a pump 16 that pumps slurry to the filter press 12. The controller 13 includes a control unit 14 and a pressure regulator 24 connected to the control unit 14. Control system 10 also includes a transducer 44 connected to the control unit 14.

In particular, and with reference to FIG. 2, in one embodiment, the pump 16 is an air-operated, double-diaphragm, positive displacement pump, and includes a fluid inlet 18 for receiving influent such as slurry, and a fluid outlet 20 for discharging the slurry to the filter press 12. The pump 16 also includes a port 22 for receiving a supply of pressurized air to drive a pair of diaphragms 32 connected by a connecting rod 33. The speed or rate of the pump 16 is dependent upon the pressure of the air supplied to the pump 16 at port 22, and in part upon the pressure of the slurry at the outlet 20. Each diaphragm 32 acts as a separation membrane between the compressed air supply in a respective air chamber 34, 35 and the slurry in a respective fluid chamber 36. An air distribution system 42 is part of the pump 16 and switches the common air supply for the pump 16 from one air chamber 34 to the second air chamber 35 in order to create suction and discharge strokes, such that one fluid chamber is being filled while the other is being discharged. The valve balls 38 open and close on valve seats 40 to direct the slurry flow from the inlet 18 to a fluid chamber 36 and then to the outlet 20. The pump 16 displaces fluid from one of its two fluid chambers 36 upon the completion of each pump stroke. When each diaphragm 32 has gone through one suction and one discharge stroke, one pumping cycle has taken place. Driving the diaphragms 32 with pressurized air instead of a connecting rod balances the loads on the diaphragms, which removes mechanical stress and extends diaphragm life.

In one embodiment, the air supply to the pump 16 is provided by the air pressure regulator 24 that is separate from the control unit 14. In other embodiments, the air pressure regulator 24 can be part of the control unit 14. Air pressure regulator 24 has an input port 26 for receiving a supply of air, a control port 28 for receiving a pneumatic control signal, and an output port 30 for supplying air to the pump 16 at a regulated pressure in accordance with the control signal. In particular, the input port is connected to a valve (not shown) that is connected to the output port 30. The valve is pneumatically controlled using a pneumatic control signal from the control unit 14, as more fully described below. The regulator 24 supplies air to the pump 16 under controlled pressures such that the rate of the pump remains substantially constant.

The transducer 44 produces an output signal indicative of the actual rate of the pump 16. The transducer 44 is coupled to the control unit 14, such that the control unit 14 receives the output signal indicative of the actual rate of the pump 16. As noted above, pump 16 displaces fluid from one of its two fluid chambers 36 upon each stroke completion, such that monitoring the movement of the diaphragms 32 or the connecting rod 33 provides an indication of the rate of the pump. In one embodiment, the transducer 30 is a switch with a set of contacts, such as in a single-pole, single throw (SPST) configuration, single-pole, double throw (SPDT) or like configuration, positioned with its operating arm in direct correspondence with the common connecting rod 33. As the connecting rod 33 reciprocates during pump operation, the switch is opened and closed and generates an electrical output signal in the form of pulses. For example, the transducer may generate one or two pulses per pump cycle, depending on the type of transducer that is used. Other possible transducers for providing output signals indicative of the pump rate include reed switches, Hall effect devices or other sensors that operate to sense a magnetic force. For example, a reed switch could sense the movement of the connecting rod 33 or auxiliary linkage to indicate each pump cycle by sensing a changing magnetic force, such as a magnet coupled to the connecting rod 33. Still other transducers may sense current applied to solenoids operating the air distribution means if used in the air-operated pump 16.

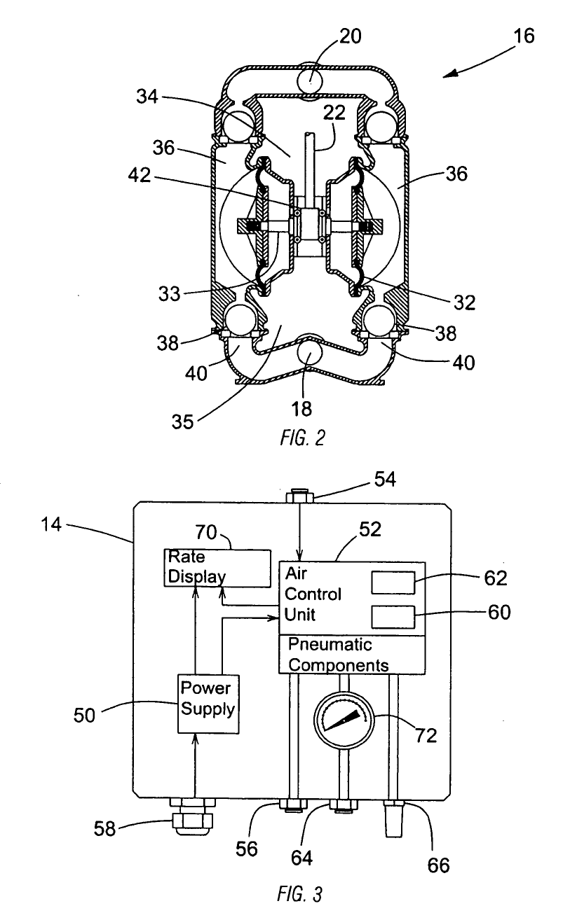

Illustrated in FIG. 3 is a schematic diagram of the control unit 14 in accordance with one embodiment for use in the control system 10 of FIG. 1. Referring to both FIG. 1 and FIG. 3, control unit 14 includes a housing 48, such as a weather tight enclosure, for enclosing a power supply 50 and an air control unit 52. The power supply 50 is connected to an AC power source via input 58 and provides power to the components of the control unit 14.

In one embodiment, the air control unit 52 includes both electronic and pneumatic components. With respect to the electronic components, the air control unit 52 receives the output signal from the transducer 44, such as a voltage or a current signal, indicative of an actual pump rate, via controller input 54. As an example, if the output signal from the transducer 44 is in the form of pulses, these pulses are counted by the air control unit 52 over a set period of time to generate an actual pump rate in units of cycles per unit time. The air control unit 52 includes an adjustable setpoint mechanism 60, such as a potentiometer, for setting a desired pump rate, and a switch 62 for switching between a manual operating mode and an automatic operating mode. Further, the control unit 14 includes a rate display 70 for displaying either the desired pump rate or an actual pump rate. The control unit 14 can also include a pressure gauge 72 that displays the pressure of a pneumatic control signal.

The separate regulator 24 allows for a greater volume of air to be supplied to the pump 16 by using larger diameter piping, for example, as compared to directly supplying air from the control unit 14. However, in other embodiments, the quantity of air supplied by the control unit 14 would be sufficient to operate the pump 16 such that a separate pressure regulator is not required. Further, in other embodiments, the air control unit 52 could include electronic control components only and produce an electronic control signal, and the air pressure regulator would include an electrically controlled valve responsive to the electronic control signal.

In the manual operating mode, the adjustable setpoint mechanism 60 can be used to set a desired pump rate. In the automatic operating mode, the air control unit 52 compares an actual pump rate to the set desired pump rate and generates a control signal. In one embodiment, the control signal is a pneumatic control signal. This is accomplished by modulating the pressure of an air supply using, for example, an electrically controlled valve, to produce the pneumatic control signal (i.e., air at a controlled pressure) as an output. Pressurized air is supplied to the air control unit 52 via port 56 and exits the air control unit 52 via port 64. In particular, the control unit 14 is operable with an input air supply of up to 150 psig via port 56. A port 66 exhausts air bled during operation of the air control unit 52.

In one embodiment, the air control unit 52 is configured with a proportional control action. In other embodiments, the air control unit 52 can be configured using either a proportional, an integral, or a derivative control action, or combinations thereof. In one embodiment, the air pressure regulator 24 and control unit 13 are remote from the pump 16.

In operation, a user first places the control unit 14 in the manual mode using switch 62. A desired pump rate can be set by moving adjusting mechanism 70 until the rate display 70 displays the desired rate. For example, the desired pump rate can be increased or decreased by rotating the adjusting mechanism 70. After the desired rate is set, the user places the control unit 14 in the automatic mode using switch 62. The pump 16 will be maintained at the desired setpoint regardless of the backpressure at the outlet 20 of the pump or other system perturbations. When switched to the automatic mode 21, the air control unit 52 disregards any attempts at changing the setpoint using the adjusting mechanism 70. The rate display 70 continually displays the actual pump rate in the automatic mode.

Although the invention herein has been described with reference to particular embodiments, it is to be understood that these embodiments are merely illustrative of the principles and applications of the present invention. It is therefore to be understood that numerous modifications maybe made to the illustrative embodiments and that other arrangements may be devised without departing from the spirit and scope of the present invention as defined by the appended claims. Various other features and advantages of the invention are set forth in the following claims.

What is claimed is:

1. A control system for controlling an air-controlled pump for pumping slurry to a filter press, wherein the pump includes a port for receiving an air supply and the rate of the pump is dependent on an air pressure at the air supply port, the system comprising:
a transducer producing an output signal indicative of the actual rate of the pump;
a controller including an adjustable setpoint mechanism for setting a desired pump rate, the controller receiving the output signal from the transducer and comparing the actual pump rate to a set desired pump rate and producing a control signal, and including an air pressure regulator for outputting a controlled air supply to the air supply port of the pump in response to the control signal.

2. The control system of claim 1, wherein the output signal of the transducer varies with each pump cycle.

3. The control system of claim 2, wherein the controller determines the number of cycles of the pump per unit time.

4. The control system of claim 1, wherein the desired pump rate is set in number of cycles per unit time.

5. The control system of claim 1, wherein the controller further includes a display for displaying one of the actual pump rate and the set desired pump rate.

6. The control system of claim 1, wherein the controller includes a switch for switching between a manual mode and an automatic mode of operation, wherein when in the manual mode, the desired pump rate can be set, and when in the automatic mode, the actual pump rate is compared to the set desired pump rate.

7. The control system of claim 1, wherein the adjustable setpoint mechanism includes a potentiometer.

8. The control system of claim 1, wherein the controller is remote from the pump.

9. The control system of claim 1, wherein the controller is adapted to provide one or more of proportional, integral and derivative control actions.

10. The control system of claim 1, wherein the transducer is a switch.

11. The control system of claim 1, wherein the switch measures a change in magnetic field due to moving parts of the pump.

12. The control system of claim 1, wherein the control signal is a pneumatic control signal.

13. The control system of claim 12, wherein the controller further includes a gauge for measuring and displaying the air pressure of the pneumatic control signal.

14. A control method for the control of an air-controlled pump pumping slurry to a filter press, wherein the pump includes an inlet for receiving an air supply, the method comprising:
pumping slurry to the filter press with the pump,
setting a desired pump rate with an adjustable rate mechanism,
sensing an actual rate of the pump,
comparing the actual pump rate to the set desired pump rate and producing a control signal, and
outputting a controlled air supply to the air supply inlet of the pump in response to the control signal to maintain the rate of the pump substantially constant.

15. The method of claim 14, wherein the comparing step is performed by a control unit.

16. The method of claim 14, wherein the desired pump rate is set in number of cycles per unit time.

17. The method of claim 14, further including displaying one of the actual pump rate and the desired pump rate.

18. The method of claim 14, further including switching between a manual mode and an automatic mode of operation, wherein when in the manual mode, the desired pump rate can be set, and when in the automatic mode, the actual pump rate is compared to the set desired pump rate.

19. The method of claim 14, further including measuring and displaying a pressure of the control signal.
